(19) United States
(12) Patent Application Publication
(10) Pub. No.: US 2012/0182836 A1
(43) Pub. Date: Jul. 19, 2012

(54) COMMUNICATION SYSTEM USING ULTRASONIC WAVES

(75) Inventors: Byung-Jae Kwak, Daejeon (KR); Kwang Chun Lee, Daejeon (KR); Hyun Kyu Chung, Daejeon (KR); Nah-Oak Song, Daejeon (KR)

(73) Assignee: Electronics and Telecommunications Research Institute, Daejeon (KR)

(21) Appl. No.: 13/496,870

(22) PCT Filed: Sep. 17, 2010
(86) PCT No.: PCT/KR2010/006446

§ 371 Date: Mar. 19, 2012

(30) Foreign Application Priority Data
Sep. 18, 2009 (KR) 10-2009-0088451
Sep. 9, 2010 (KR) 10-2010-0088389

(51) Int. Cl. G01S 3/80; H04B 11/00

(52) U.S. Cl. 367/118; 367/135

(57) ABSTRACT

Disclosed is a technology for performing a communication using an ultrasonic wave in an environment where an electromagnetic shielding is so severe that a wireless communication using an electromagnetic is difficult. In the environment where the electromagnetic shielding is severe, an ultrasonic terminal according to the present invention may transmit the ultrasonic wave using a solid structure as a medium, and an ultrasonic base station may receive the ultrasonic wave using the solid structure as the medium.

### TECHNICAL FIELD

The present invention relates to a communication system using an ultrasonic wave, and more particularly, to a communication system transmitting an ultrasonic wave via a solid medium in an environment where an electromagnetic shielding is severe, and transmitting voice or data using the transmitted ultrasonic wave.

### BACKGROUND ART

In a shipbuilding business, making an improvement in efficiency of building ships, such as building ships at a low cost and in a short period of time, and the like may be important in maintaining a competitive edge in the shipbuilding industry being a national key industry.

In a ship that is being built, an assembly order of each part may be determined based on a construction stage of the ship, and a progress and an accident condition of a part may be shared with other parts. Accordingly, a communication system may be urgently required when building ships. For example, when a design with respect to a part of the ship being built is changed, a workplace where the changed part is under construction may need to rapidly receive the changed design, and the other parts may need to change an order of building the ship to reflect the changed design. Design and construction of other parts may also need to be changed.

However, within the ship where electromagnetic shielding is severe, a wireless communication environment may be poor, and utilizing a conventional wireless communication technology using electromagnetic waves may be difficult. Due to problems such as costs, time, constant changes in the internal environment depending on the building operation of the ship, and the like, it may be difficult to install a wired communication system during the construction of the ship.

### DISCLOSURE OF INVENTION

### Technical Goals

An aspect of the present invention is to transmit data using an ultrasonic wave.

An aspect of the present invention is to transmit data in an environment where an electromagnetic shielding is severe.

### Technical Solutions

According to an aspect of the present invention, there is provided an ultrasonic terminal including a transducer to convert, to a first electrical signal, a first ultrasonic wave received from an ultrasonic base station or a second ultrasonic terminal via a solid medium, a receiver to convert the first electrical signal to first data, and a transmitter to convert second data to a second electrical signal, wherein the transducer converts the second electrical signal to a second ultrasonic wave, and transmits the converted second ultrasonic wave to the ultrasonic base station or the second ultrasonic terminal via the solid medium.

According to another aspect of the present invention, there is provided an ultrasonic base station including a transducer to convert, to an electrical signal, an ultrasonic wave received from an ultrasonic terminal via a solid medium, a receiver to convert the electrical signal to data, and a data communication unit to transmit the data to a server using a communication network.

According to still another aspect of the present invention, there is provided a location estimating apparatus including a transducer to receive a reference ultrasonic wave from an ultrasonic terminal via a solid medium, a signature generator to generate a signature for estimating a location of the ultrasonic terminal based on the reference ultrasonic wave, and a location estimating unit to estimate the location of the ultrasonic terminal based on the signature.

According to the present invention, data may be transmitted using an ultrasonic wave. According to the present invention, data may be transmitted in an environment where an electromagnetic shielding is severe.

### BRIEF DESCRIPTION OF DRAWINGS

FIG. 1 illustrates an example of an ultrasonic communication system in an environment where an electromagnetic shielding is severe.

FIG. 2 illustrates another example of an ultrasonic communication system in an environment where an electromagnetic shielding is severe.

FIG. 3 illustrates still another example of an ultrasonic communication system in an environment where an electromagnetic shielding is severe.

FIG. 4 illustrates a case where two independent cells are wirelessly connected to configure multiple cells.

FIG. 5 illustrates a central command center wirelessly connected to an ultrasonic communication system inside of a ship.

FIG. 6 illustrates transmitting and receiving data using an ultrasonic terminal having a Multiple Input Multiple Output (MIMO) function.

FIG. 7 illustrates that three user groups are connected by an ultrasonic communication.

FIG. 8 illustrates a concept of an impulse response in an ultrasonic communication.

FIG. 9 illustrates estimating a location using an ultrasonic communication.

FIG. 10 illustrates an example of communicating with a survivor using an ultrasonic wave in a case where a ship sank.

FIG. 11 illustrates a configuration of an ultrasonic terminal according to an aspect of the present invention.

FIG. 12 illustrates a configuration of an ultrasonic base station according to an aspect of the present invention.

FIG. 13 illustrates a configuration of a location estimating apparatus according to another aspect of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

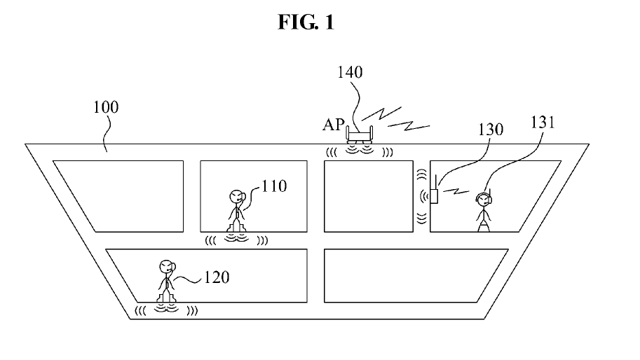

FIG. 1 illustrates an example of an ultrasonic communication system in an environment where an electromagnetic shielding is severe.

A ship 100 may have a structure composed of a material that severely shields an electromagnetic wave, and a communication system using a general electromagnetic wave may not be applied.

Engineers working inside of the ship 100 may transmit data using the ultrasonic communication system. The ultrasonic communication system may include ultrasonic terminals 110, 120, and 130, and an ultrasonic base station 140. The ultrasonic terminals 110, 120, and 130 perform a communication in a peer to peer form, and may perform the communication via an ultrasonic base station 140.

According to an aspect of the present invention, while an engineer works inside of the ship, the engineer may be in contact with a body of the ship 100 via a foot or both feet. Thus, the ultrasonic terminal 110 and 120 may contact the body of the ship 100 through a shoe or shoes of the engineer, and may transmit an ultrasonic wave using the contacted body of the ship 100.

According to another aspect of the present invention, the ultrasonic terminal 130 may receive an audio signal via a headset 131 of the engineer. The ultrasonic terminal 130 may convert the audio signal to the ultrasonic wave, and may transmit the converted ultrasonic wave.

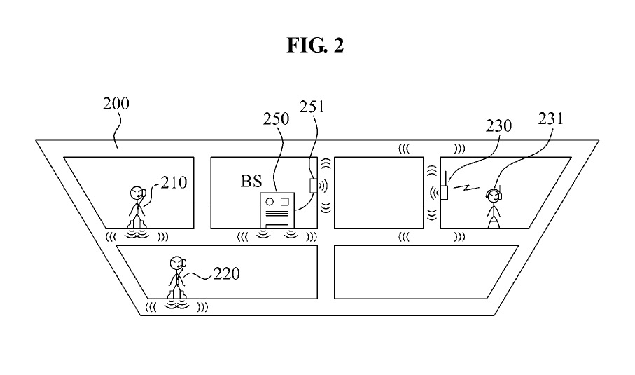

FIG. 2 illustrates another example of an ultrasonic communication system in an environment where an electromagnetic shielding is severe.

Referring to FIG. 2, a body 200 of a ship may configure a single cell, and a plurality of ultrasonic terminals 210, 220, and 230 inside of the body 200 of the ship may be serviced by a single ultrasonic base station 250.

The ultrasonic base station 250 may include a transducer 251 or a plurality of transducers. The transducer 251 of the ultrasonic base station 250 may be installed in the body 200 of the ship to transmit and receive the ultrasonic wave via the body 200 of the ship.

According to an aspect, the ultrasonic base station 250 may receive data from a first ultrasonic terminal 210 using the ultrasonic wave. The ultrasonic base station 250 may transmit the received data to a second ultrasonic terminal 220 using the ultrasonic wave.

The engineers may carry the ultrasonic terminals 210, 220, and 230. Since the engineers may contact the body 200 of the ship with feet, the transducer may be attached to shoes, and the terminal may be in wired or wireless contact with the transducer.

In a case where the ultrasonic base station 250 uses a plurality of transducers, the ultrasonic base station 250 may transmit or receive the ultrasonic wave using a Multiple Input Multiple Output (MIMO) transmitting scheme. In this case, the ultrasonic base station 250 may transmit a plurality of data streams using the plurality of transducers. The ultrasonic terminals 210, 220, and 230 may receive a signal in which different data streams are mixed, using several transducers. The ultrasonic terminals 210, 220, and 230 may divide different data streams using an MIMO signal processing scheme. Since the ultrasonic base station 250 and the ultrasonic terminals 210, 220, and 230 may transmit the plurality of data streams, data transmission efficiency may be improved.

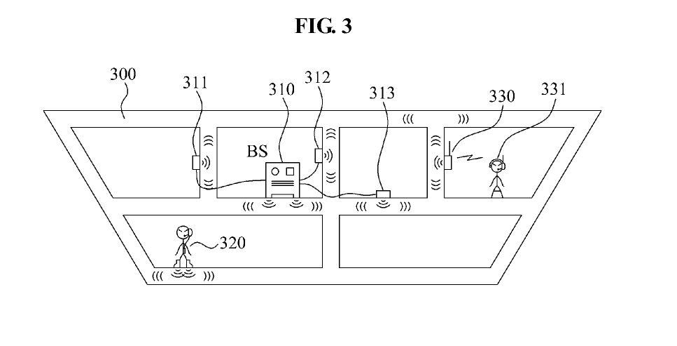

FIG. 3 illustrates still another example of an ultrasonic communication system in an environment where an electromagnetic shielding is severe.

In a cellular system, various types of repeaters may be used to extend a cell coverage of a base station, or to provide a service to a terminal located in a dead spot where a signal from the base station may not reach. Similarly, when a body 300 of a ship is excessively large, an ultrasonic wave transmitted by an ultrasonic base station 310 installed at a predetermined location may not maintain a sufficient magnitude until the ultrasonic wave reaches other parts of the body 300 of the ship.

FIG. 3 illustrates an example of reducing the dead spot or extending the cell coverage of the ultrasonic base station 310, using a plurality of repeaters 311, 312, and 313 in a communication using the ultrasonic wave.

Referring to FIG. 3, the ultrasonic base station 310 may transmit data in a wired or wireless manner to the ultrasonic repeaters 311 and 313 located at a relatively far distance. Each of the ultrasonic repeaters 311 and 313 may convert the data received from the ultrasonic base station 310 to the ultrasonic wave, and may transmit the ultrasonic wave to ultrasonic terminals 320 and 330. An engineer may make a call initiate communication via the ultrasonic terminal 330 using a headset 331, and the like.

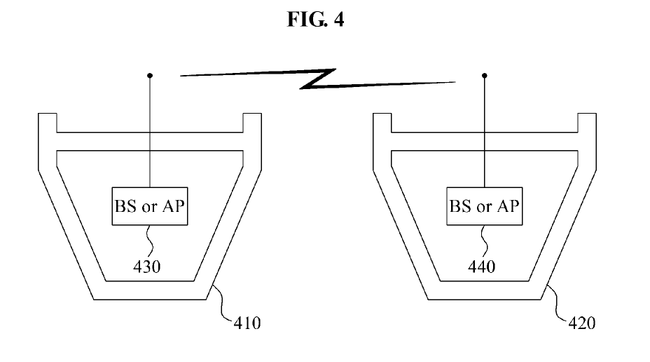

FIG. 4 illustrates a case where two independent cells are wirelessly connected to configure multiple cells. Referring to FIG. 4, two ships 410 and 420 may configure two cells. The two cells may be connected by a wireless link. The wireless link may correspond to a link directly connecting the two ships 410 and 420, and may correspond to a logical link connected using a backbone network.

A communication between the two cells may be performed through ultrasonic base stations 430 and 440, or may be performed through a gateway terminal In this case, a first ultrasonic base station 430 may transmit data to a second ultrasonic base station 440 using an electromagnetic wave.

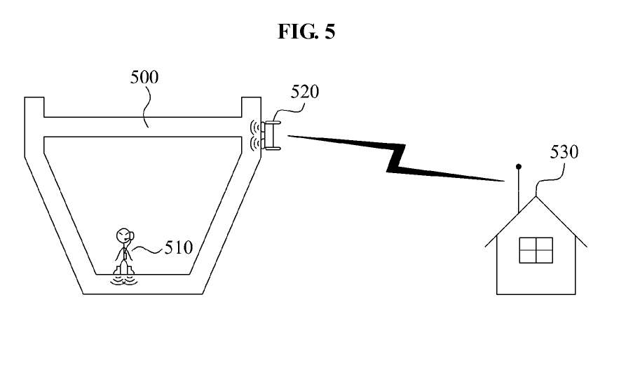

FIG. 5 illustrates a central command center 530 wirelessly connected to an ultrasonic communication system inside of a ship. While a body 500 of the ship is being built, a number of cases and accidents, or an accident of great urgency may occur inside of the body 500 of the ship. In this case, an engineer may communicate with the central command center 530 via an ultrasonic terminal 510 and an ultrasonic base station 520. Since the engineer may promptly report an accident location and accident condition, an emergency rescue operation may be accurately and promptly operated.

For example, the engineer may report an accident occurrence using the ultrasonic terminal 510. In this case, the engineer may control the ultrasonic terminal 510 so that the ultrasonic terminal 510 may transmit an ultrasonic signal having a predetermined pattern to the ultrasonic base station 520, by operating the ultrasonic terminal 510. The ultrasonic base station 520 may determine whether an accident occurs based on the ultrasonic signal having the predetermined pattern, and may transmit the determination result regarding whether the accident occurs to the central command center 530 using an electromagnetic wave.

According to another aspect, the ultrasonic terminal 510 may determine whether the accident occurs using a sensor, and may transmit the ultrasonic signal of the predetermined pattern to the ultrasonic base station 520 based on the determination result.

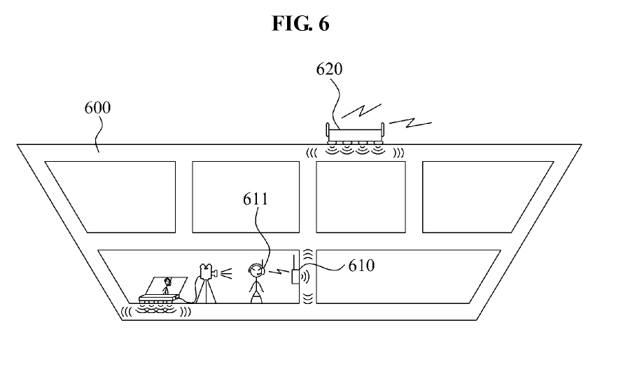

FIG. 6 illustrates transmitting and receiving data using an ultrasonic terminal having an MIMO function.

A transmission speed of an ultrasonic wave may be slower than the transmission speed of an electromagnetic wave. The transmission speed of the ultrasonic wave may be determined based on a receive sensitivity of a transducer, a frequency bandwidth of the ultrasonic wave that the transducer may generate, a transmission power of the ultrasonic wave, a channel characteristic of the ultrasonic wave, and the like. A multimedia signal such as a picture and video, and mass storage data such as a drawing may require a data transfer rate higher than the data transfer rate of an audio signal. To satisfy the requirement, an MIMO transmitting scheme using an ultrasonic terminal 610 having a plurality of transducers and an ultrasonic base station 620 having the plurality of transducers may be applied.

FIG. 6 illustrates an embodiment of transmitting video data using the plurality of transducers between the ultrasonic terminal 610 located inside of a body 600 of a ship and the ultrasonic base station 620 located on a surface of the body 600 of the ship.

In this case, the ultrasonic base station 620 may transmit a plurality of data streams using the plurality of transducers. The ultrasonic terminal 610 may receive, using the plurality of transducers, a signal in which each data stream is maxed, and may divide different streams using an MIMO signal processing scheme. Since the ultrasonic base station 620 may simultaneously transmit the plurality of data streams to the ultrasonic terminal 610, data transmission efficiency may be improved. The embodiment of transmitting, by the ultrasonic base station 620, the plurality of data streams to the ultrasonic terminal 610 is described with reference to FIG. 6. However, in a case where the ultrasonic terminal 610 transmits the data stream to the ultrasonic base station 620 using the plurality of transducers, the ultrasonic terminal 610 and the ultrasonic base station 620 may perform a similar operation to the example of FIG. 6 to improve the data transmission efficiency from the ultrasonic terminal 610 to the ultrasonic base station 620.

The ultrasonic terminal transmitting data using the ultrasonic wave has been described with reference to FIG. 1 through FIG. 6. The ultrasonic terminal may be generally separated into a transducer part attached to the ship, and a part receiving data from a user in a form of a headset. However, according to an embodiment, the ultrasonic terminal may be a wall mount type or a wearable type. Regardless of the type, the ultrasonic terminal may be attached to a solid medium such as the body of the ship, and may transmit data using the transducer that converts a vibration of a medium to an electrical signal, or converts the electrical signal to the vibration of the medium.

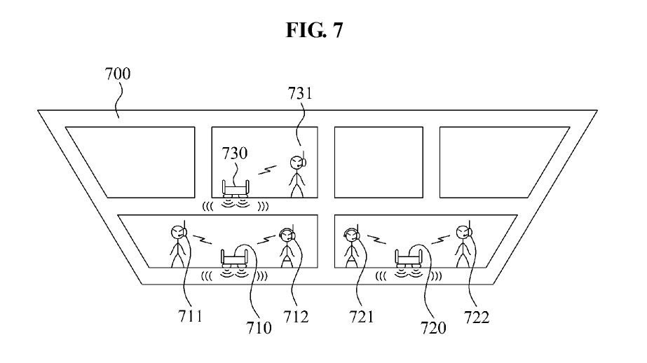

FIG. 7 illustrates that three user groups are connected by an ultrasonic communication.

A plurality of ultrasonic base stations 710, 720, and 730 may exist inside of a body 700 of a ship. Each of the ultrasonic base stations 710, 720, and 730 may communicate with an ultrasonic terminal grouped into the same group as a group of the each ultrasonic base station among a plurality of ultrasonic terminals 711, 712, 721, 722, and 731. Referring to FIG. 7, a first ultrasonic base station 710 may be grouped into the same group as a group of the ultrasonic terminal 711 and the ultrasonic terminal 712 to communicate with the ultrasonic terminal 711 and the ultrasonic terminal 712.

A second ultrasonic base station 720 may be grouped into the same group as a group of the ultrasonic terminal 721 and the ultrasonic terminal 722 to communicate with the ultrasonic terminal 721 and the ultrasonic terminal 722. A third ultrasonic base station 730 may be grouped into the same group as a group of the ultrasonic terminal 731 to communicate with the ultrasonic terminal 731.

The ultrasonic terminals 711, 712, 721, 722, and 731 belonging to different groups may communicate with each other via the ultrasonic base station 710, 720, and 730. For example, the ultrasonic terminal 731 and the ultrasonic terminal 712 are ultrasonic terminals belonging to different groups. The ultrasonic terminal 731 may communicate with the ultrasonic base station 730 included in the same group, and the ultrasonic base station 730 may communicate with the ultrasonic base station 710 belonging to a group where the ultrasonic terminal 712 is included. Further, the ultrasonic base station 710 may communicate with the ultrasonic terminal 712. Data between the ultrasonic terminal 731 and the ultrasonic terminal 712 may be transmitted through a route formed by the ultrasonic terminal 731, the ultrasonic base station 730, the ultrasonic base station 710, and the ultrasonic terminal 712.

According to an aspect, data may be transmitted between the ultrasonic terminal 731 and the ultrasonic base station 730, and between the ultrasonic terminal 712 and the ultrasonic base station 730, using the ultrasonic wave, and data may be transmitted between the ultrasonic base station 710 and the ultrasonic base station 712, using an electromagnetic wave.

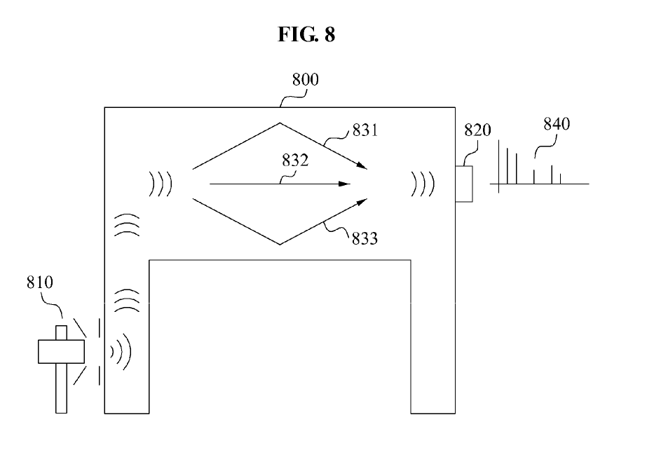

FIG. 8 illustrates a concept of an impulse response in an ultrasonic communication.

An ultrasonic terminal 810 may transmit an ultrasonic wave to a location estimating apparatus 820, using a body 800 of a ship. The ultrasonic wave may be transmitted along each part inside of the body 800 of the ship, through several routes 831, 832, and 833. The ultrasonic wave may be transmitted to the location estimating apparatus 820 at time intervals based on a length of the route. When the length of the route is short, a transmission time of the ultrasonic wave may be short. When the length of the route is long, a transmission time of the ultrasonic wave may be long.

When the ultrasonic terminal 810 generates the ultrasonic wave in a form of an impulse, the location estimating apparatus 820 may receive the ultrasonic wave transmitted through the several routes, and the ultrasonic wave may be received along several channels 840 over time. An illustrated levels of the ultrasonic waves received using the several routes may correspond to an impulse response 840 of an ultrasonic wave channel. Transmitting the impulse may be inefficient since a great amount of energy may be transmitted for a relatively short period of time. Thus, the location estimating apparatus 820 may modulate a pseudo-random sequence signal such as an “m sequence” and the like, and may estimate a location of the ultrasonic terminal 810 using the modulated signal. In this case, the location estimating apparatus 820 may obtain the impulse response of the channel from the received random sequence. The location estimating apparatus 820 may estimate the location of the ultrasonic terminal 810 from a received data packet.

A transmission route of the ultrasonic wave may be determined based on the locations of the ultrasonic terminal 810 and the location estimating apparatus 820. When the location of the location estimating apparatus 820 is fixed, the transmission route of the ultrasonic wave may be determined based on the location of the ultrasonic terminal 810.

Since the impulse response 840 of the ultrasonic wave channel may be determined based on the transmission route of the ultrasonic wave, and the transmission route of the ultrasonic wave may be determined based on the location of the ultrasonic terminal 810, the location of the ultrasonic terminal 810 may be estimated by analyzing the impulse response 840 of the ultrasonic wave.

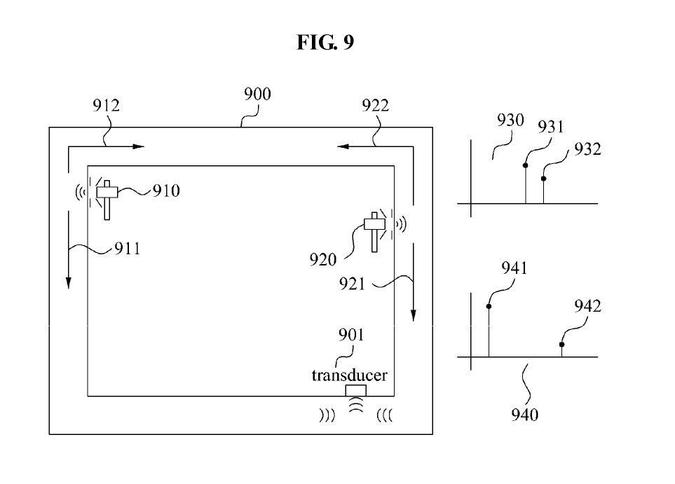

FIG. 9 illustrates estimating a location using an ultrasonic communication.

Referring to FIG. 9, two routes 911 and 912 may exist between a first ultrasonic terminal 910 and a location estimating apparatus 901. Since the two routes are different from each other, arrival time during which an ultrasonic wave transmitted by the first ultrasonic terminal 910 arrives at the location estimating apparatus 901 may be different between the two routes 911 and 912. In a case of a second ultrasonic terminal 920, two routes 921 and 922 may exist, and arrival time during which the ultrasonic wave transmitted by the second ultrasonic terminal 920 arrives at the location estimating apparatus 901 may be different between the two routes 921 and 922.

Thus, the locations of the ultrasonic terminals 910 and 920 each transmitted the ultrasonic signal may be estimated based on a unique characteristic according to a location included in the received ultrasonic signal. For example, the location estimating apparatus 901 may store the impulse response of the ultrasonic wave channel with respect to each part of the ship, and may estimate the locations of the ultrasonic terminals 910 and 920 by comparing the impulse response of the received ultrasonic wave channel with the impulse response of the stored ultrasonic wave channel.

Since directly storing the impulse response may require a mass storage device, parameters including location information extracted from the impulse response may be extracted to be stored instead of the impulse response, and the location may be estimated by extracting the parameters including the location information from the (*a channel impulse response of the ultrasonic signal. Here, the parameters including the location information may refer to a signature with respect to the location information.

According to an aspect, the location estimating apparatus 901 may select a delay profile similar to a received delay profile among stored delay profiles, by comparing the delay profile of the impulse response of the received ultrasonic wave channel with the delay profile of the impulse response of the stored ultrasonic wave channel. According to an aspect, the location estimating apparatus 901 may estimate, as the locations of the ultrasonic terminals 910 and 920, an ultrasonic wave transmission location of the delay profile similar to the received delay profile.

According to an aspect, the ultrasonic terminals 910 and 920 may transmit a pseudo-random sequence instead of transmitting the impulse, and the location estimating apparatus 901 may extract the impulse response from the received signal of the pseudo-random sequence.

According to another aspect, the location estimating apparatus 901 may extract the parameters including unique location information of the ultrasonic terminals 910 and 920 from the received signal, and may estimate the locations of the ultrasonic terminals 910 and 920 using the extracted parameters.

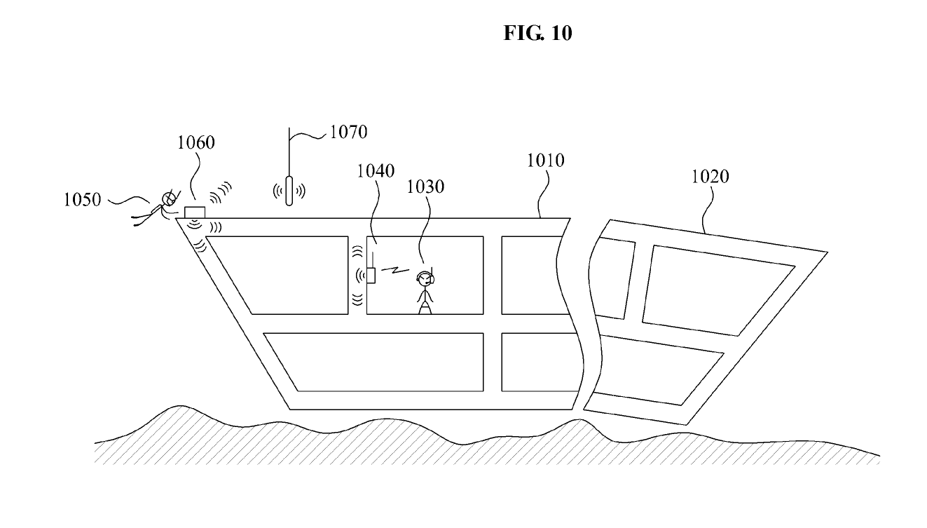

FIG. 10 illustrates an example of communicating with a survivor using an ultrasonic wave in a case where a ship sank.

Referring to FIG. 10, the ship may be separated into two parts 1010 and 1020, and may sink completely. A survivor 1030 may be located in a part 1010 of the sunken ship. In a general case, since whether the survivor 1030 is alive or dead may not be determined outside of the ship, determining between a rescue work and a salvage work may not be possible.

According to the present invention, the survivor 1030 may easily inform that the survivor 1030 is alive by communicating with an ultrasonic base station 1060 using an ultrasonic terminal 1040. According to an aspect, a diver 1050 performing the rescue work may communicate with the survivor 1030 by directly operating the ultrasonic base station 1060.

According to another aspect, the ultrasonic base station 1060 may transmit a communication content with the ultrasonic terminal 1040 to water using an underwater ultrasonic communication. In this case, the ultrasonic base station 1060 may transmit the communication content the survivor 1030 to an underwater ultrasonic communication transceiver 1070. According to an aspect, the underwater ultrasonic communication transceiver 1070 may transmit the communication content to a rescue ship in a wired manner.

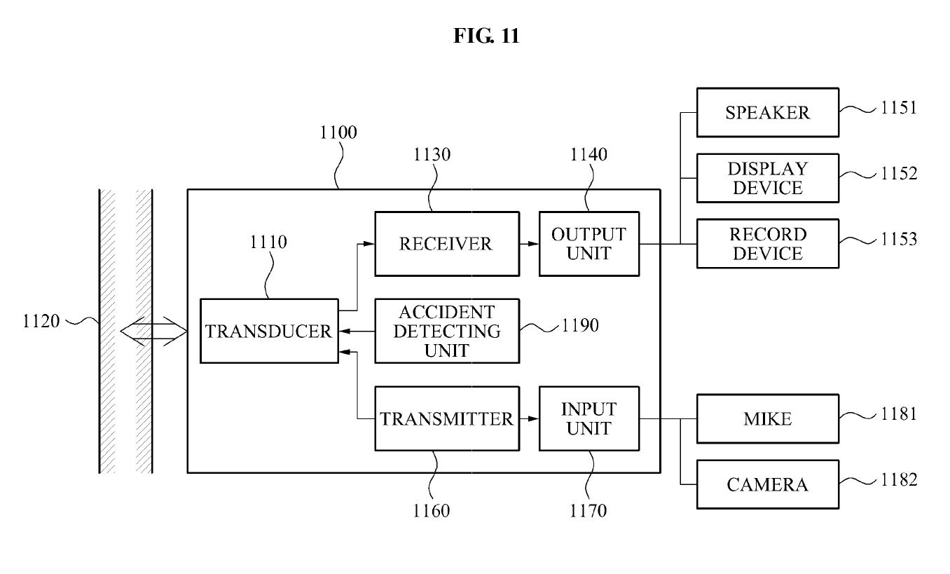

FIG. 11 illustrates a configuration of an ultrasonic terminal 1100 according to an aspect of the present invention. The ultrasonic terminal 1100 may include a transducer 1110, a receiver 1130, an output unit 1140, a transmitter 1160, an input unit 1170, and an accident detecting unit 1190.

Referring to FIG. 11, the ultrasonic terminal 1100 may receive or transmit data using an ultrasonic wave. Hereinafter, in FIG. 11, the ultrasonic wave that the ultrasonic terminal 1100 receives to receive data may refer to a first ultrasonic wave, and the ultrasonic wave that the ultrasonic terminal 1100 transmits to transmit data may refer to a second ultrasonic wave.

The transducer 1110 may be a device converting a vibration of a medium to an electrical signal, or converting the electrical signal to the vibration of the medium. The ultrasonic wave that an ultrasonic base station transmits may be transmitted through a ship 1120. When the ultrasonic wave is transmitted, the ship 1120 may vibrate. The transducer 1110 may detect the ultrasonic wave using the vibration of the ship 1120.

The transducer 1110 may convert, to a first electrical signal, the first ultrasonic wave received from the ultrasonic base station or a second ultrasonic terminal via a solid medium such as the ship 1120. The ship 1120 may generally be composed of a metal to have electromagnetic wave shielding properties, and may include several relatively small spaces separated by partitions. The electromagnetic wave may be difficult to be transmitted between different spaces separated by partitions, and an ordinary telecommunication using the electromagnetic wave may be difficult to be used inside of the ship 1120. The transducer 1110 may transmit the first electrical signal to the receiver 1130.

The receiver 1130 may receive the first electrical signal from the transducer 1110, and may convert the received first electrical signal to first data. According to an aspect, the converting process may include a demodulation process and a decoding process.

Although FIG. 11 illustrates an embodiment in which the transducer 1110, the receiver 1130, and the transmitter 1160 are all included inside of the ultrasonic terminal 1100, the transducer 1110 may be located outside of the ultrasonic terminal 1100 according to another embodiment. In this case, the transducer 1110 may be a wall-mount type communication device, and the receiver 1130 and the transmitter 1160 may have a headset type wirelessly connected to a wall-mount type communication device.

According to another embodiment, the ultrasonic terminal 1100 may be a wearable type that an engineer inside of the ship 1120 wears. In this case, the transducer 1110 may be disposed on a portion that contacts the ship 1120, such as shoes of the engineer, and the receiver 1130 and the transmitter 1160 may be located at a portion of clothes that the engineer wears. The transducer 1110 and the receiver 1130, the transducer 1110 and the transmitter 1160 may be connected in a wired or wireless manner.

The output unit 1140 may output the first data to a speaker 1151, a display device 1152, a record device 1153, and the like. For example, in a case where the first data corresponds to audio data, the output unit 1140 may replay the first data using the speaker 1151. In a case where the first data corresponds to video data, the output unit 1140 may display the first data using the display device 1152. The output unit 1140 may record the first data on a separate record device 1153.

The transmitter 1160 may convert second data to a second electrical signal. According to an aspect, the second data may correspond to an audio signal. In this case, an input unit 1170 may receive a recorded voice using a mike 1181. The transmitter 1160 may convert the recorded voice to a second electrical signal. According to another aspect, the second data may correspond to a video signal. In this case, the input unit 1170 may received a taken video using a camera 1182. The transmitter 1160 may convert the taken video to the second electrical signal. The converting process may include an encoding process and a modulation process.

The transducer 1110 may convert the second electrical signal to the second ultrasonic wave, and may transmit the converted second ultrasonic wave to the ultrasonic base station or the second ultrasonic terminal via the solid medium 1120. According to an aspect, the transducer 1110 may vibrate the solid medium 1120 according to the second ultrasonic wave to transmit the second ultrasonic wave to the ultrasonic base station or the second ultrasonic terminal

According to an aspect, the ultrasonic terminal 1100 may include an accident detecting unit 1190. The accident detecting unit 1190 may detect whether an accident with respect to a user of the ultrasonic terminal 1100 occurs.

According to an aspect, the accident detecting unit 1190 may detect a direction of force applied to the ultrasonic terminal 1100 using a gravity sensor and the like. When the user of the ultrasonic terminal 1100 is in an accident, or the user stumbles, the ultrasonic terminal 1100 may receive a strong force in an instant. In this case, the accident detecting unit 1190 may detect that the user is in an accident. The transducer 1110 may transmit, to the ultrasonic base station or the second ultrasonic terminal via the solid medium 1120, a detection result regarding whether the accident occurs.

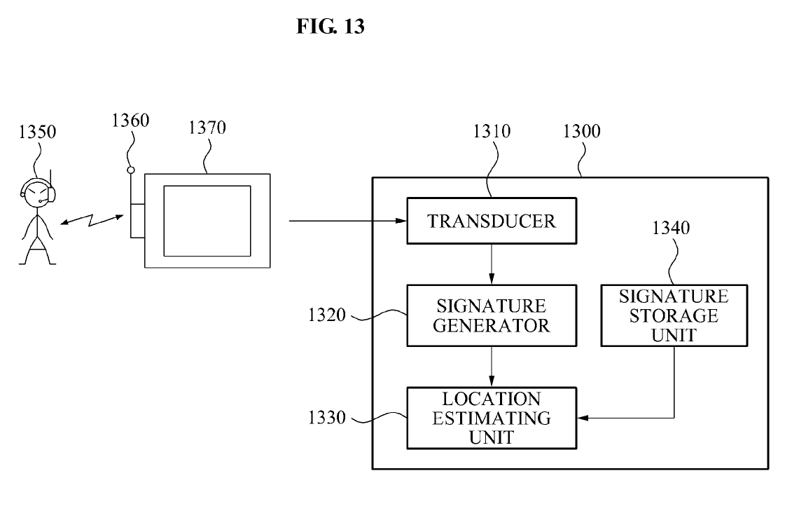

According to an aspect, the ultrasonic terminal 1100 may use the ultrasonic wave to estimate a location of the ultrasonic terminal 1100. In this case, the transducer 1110 may transmit a predetermined reference ultrasonic wave to a location estimating apparatus. A pattern of the reference ultrasonic wave may be predetermined between the ultrasonic terminal 1100 and the location estimating apparatus. A configuration of estimating the location of the ultrasonic terminal 1100 using the reference ultrasonic wave will be described with reference to FIG. 13.

According to an aspect, the ultrasonic terminal 1100 may determine whether a communication using the ultrasonic wave is possible. According to an aspect, when the ultrasonic terminal 1100 may not receive the first ultrasonic wave transmitted via the ship, or may not transmit the second ultrasonic wave, the communication using the ultrasonic wave may not be possible for the ultrasonic terminal 1100. Thus, transducer 1110 may determine whether the first ultrasonic wave may be received from the ultrasonic base station or the second ultrasonic terminal, and may determine whether the communication using the ultrasonic wave is possible, based on the determination result regarding whether the first ultrasonic wave may be received from the ultrasonic base station or the second ultrasonic terminal.

According to another aspect, in a case where the transducer 1110 and the receiver 1130 are wirelessly connected to each other, the receiver 1130 and the transducer 1110 may be maximum communication distance or more apart. In this case, the transducer 1110 may not transmit the electrical signal to the receiver 1130.

The receiver 1130 may receive the electrical signal from the transducer 1110, and may determine whether the communication using the ultrasonic wave is possible based on the receipt result.

According to another aspect, the output unit 1140 may output information about whether the communication using the ultrasonic wave is possible.

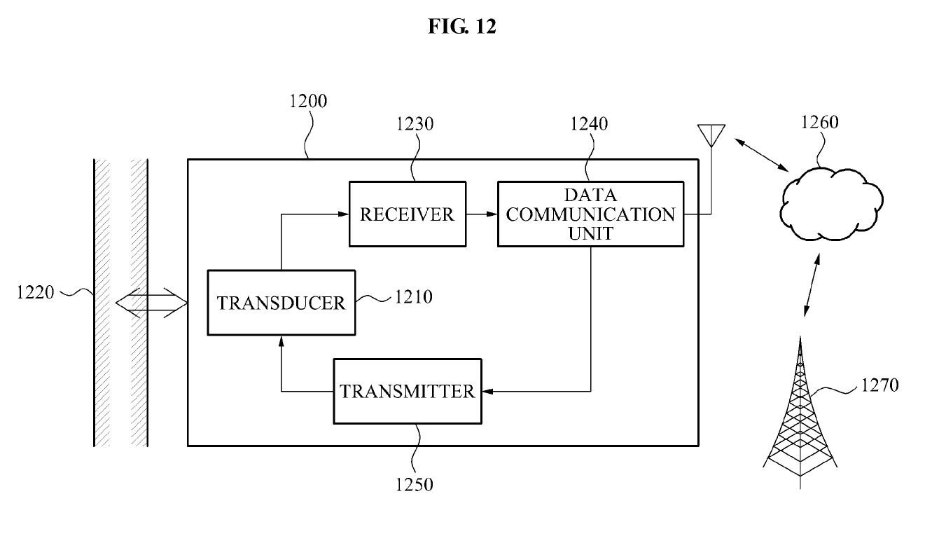

FIG. 12 illustrates a configuration of an ultrasonic base station 1200 according to an aspect of the present invention. The ultrasonic base station 1200 may include a transducer 1210, a receiver 1230, a transmitter 1250, and a data communication unit 1240.

The transducer 1210 may convert, to a first electrical signal, an ultrasonic wave transmitted from an ultrasonic terminal using a solid medium 1220. According to an aspect, the solid medium 1220 may correspond to a body of a ship, and may have electromagnetic wave shielding properties.

The receiver 1230 may convert the first electrical signal to first data. According to an aspect, the receiver 1230 may perform a demodulation with respect to the first electrical signal, and may decode the first electrical signal to the first data.

The data communication unit 1240 may transmit the first data to a server 1270 using a communication network 1260. The data communication unit 1240 may receive second data from the server 1270 using the communication network 1260.

The transmitter 1250 may convert the second data to a second electrical signal. According to an aspect, the transmitter 1250 may encode the second data, and may modulate the encoded second data to convert the second data to the second electrical signal.

The transducer 1210 may convert the second electrical signal to an ultrasonic wave, and transmit the converted ultrasonic wave to the ultrasonic terminal or another ultrasonic base station via the solid medium 1220.

FIG. 13 illustrates a configuration of a location estimating apparatus 1300 estimating a location using an ultrasonic wave according to an aspect of the present invention.

The location estimating apparatus 1300 may include a transducer 1310, a signature generator 1320, a location estimating unit 1330, and a signature storage unit 1340.

A user 1350 may operate an ultrasonic terminal 1360 to generate a reference ultrasonic wave that may be used for position recognition. According to another aspect, the ultrasonic terminal 1360 may periodically generate the reference ultrasonic wave without the operation of the user. According to still another aspect, the ultrasonic terminal 1360 may detect an occurrence of a certain circumstance such as an accident, and may transmit the ultrasonic signal for the position recognition.

The generated reference ultrasonic wave may be transmitted using a ship 1370 corresponding to the solid medium.

The transducer 1310 may receive the reference ultrasonic wave transmitted via the solid medium.

The signature generator 1320 may generate a signature for location estimation of the ultrasonic terminal 1360 based on the reference ultrasonic wave. The signature may be a type of parameter for the location estimation of the ultrasonic terminal 1360. According to an aspect, the signature may correspond to a parameter set including a plurality of parameters for the location estimation of the ultrasonic terminal 1360. According to another aspect, the reference ultrasonic wave may correspond to an impulse described with reference to FIG. 8. In this case, a delay profile of the reference ultrasonic wave described with reference to FIG. 8 may be used as an example of the signature.

The location estimating unit 1330 may estimate the location of the ultrasonic terminal 1360 based on the signature generated based on the reference ultrasonic wave. According to an aspect, the signature generator 1320 may generate the signatures according to the ultrasonic wave transmitted from each part of the ship 1370 composed of the solid medium. The generated signatures may refer to reference signatures. The signatures may be generated with respect to each part of the ship 1370. The signature storage unit 1340 may store the reference signatures.

According to an aspect, the location estimating unit 1330 may compare the signature generated with reference to the ultrasonic terminal 1360 with the reference signatures. The location estimating unit 1330 may select a reference signature most similar to the signature generated with reference to the ultrasonic terminal 1360, among the reference signatures. The location estimating unit 1330 may estimate, as the location of the ultrasonic terminal 1360, a location on the ship 1370, corresponding to the most similar reference signature.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An ultrasonic terminal comprising:
a transducer to convert, to a first electrical signal, a first ultrasonic wave received from an ultrasonic base station or a second ultrasonic terminal via a solid medium;
a receiver to convert the first electrical signal to first data; and
a transmitter to convert second data to a second electrical signal,
wherein the transducer converts the second electrical signal to a second ultrasonic wave, and transmits the converted second ultrasonic wave to the ultrasonic base station or the second ultrasonic terminal via the solid medium.

2. The ultrasonic terminal of claim 1, wherein the transducer converts a vibration of the solid medium occurring due to the first ultrasonic wave to the first electrical signal, and transmits the second ultrasonic wave by vibrating the solid medium according to the second ultrasonic wave.

3. The ultrasonic terminal of claim 1, wherein the solid medium corresponds to a body of a ship.

4. The ultrasonic terminal of claim 1, wherein the solid medium has electromagnetic wave shielding properties.

5. The ultrasonic terminal of claim 1, further comprising:
an output unit to output the first data to a speaker or a headset, to display the first data on a display device, or to record the first data on a record device.

6. The ultrasonic terminal of claim 1, wherein the transducer transmits a reference ultrasonic wave, and a location of the ultrasonic terminal is estimated based on the reference ultrasonic wave.

7. The ultrasonic terminal of claim 1, further comprising:
an output unit,
wherein the receiver determines whether the receiver is capable of receiving the first electrical signal from the ultrasonic base station, and
the output unit displays whether the reception has succeeded.

8. The ultrasonic terminal of claim 1, further comprising:
an accident detecting unit to detect whether an accident with respect to a user of the ultrasonic terminal occurs,
wherein the transducer transmits, to the ultrasonic base station via the solid medium, a detection result regarding whether the accident with respect to the user of the ultrasonic terminal occurs.

9. An ultrasonic base station comprising:
a transducer to convert, to an electrical signal, an ultrasonic wave received from an ultrasonic terminal via a solid medium;
a receiver to convert the electrical signal to data; and
a data communication unit to transmit the data to a server using a communication network.

10. The ultrasonic base station of claim 9, wherein the solid medium corresponds to
a body of a ship, and the solid medium has electromagnetic wave shielding properties.

11. A location estimating apparatus comprising:
a transducer to receive a reference ultrasonic wave from an ultrasonic terminal via a solid medium;
a signature generator to generate a signature for estimating a location of the ultrasonic terminal based on the reference ultrasonic wave; and
a location estimating unit to estimate the location of the ultrasonic terminal based on the signature.

12. The location estimating apparatus of claim 11, wherein the signature corresponds to a delay profile of the reference ultrasonic wave.

13. The location estimating apparatus of claim 11, wherein the location estimating apparatus compares the generated signature with reference signatures generated with respect to different locations of the solid medium, and estimates, as the location of the ultrasonic terminal, a location corresponding to the most similar signature to the generated signature among the reference signatures.
